(19) United States
(12) Patent Application Publication
(10) Pub. No.: US 2003/0120626 A1
(43) Pub. Date: Jun. 26, 2003

(54) Voice-enabled, consumer transaction system

(75) Inventor: Tony Piotrowski, Wayne, NJ (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/024,757

(22) Filed: Dec. 20, 2001

(51) Int. Cl. G06F 7/00

(52) U.S. Cl. 707/1

(57) ABSTRACT

A system and method for facilitating offline voice enabled consumer transactions. The system may include a voice browser and a voice recognition system. Using information contained in a voice data packet created by a user, the system can search various structured and unstructured databases to determine one or more matches relating to the voice data packet. This can be performed in a non-real time manner. If the desired item or service is found, the user can purchase the item or service.

### FIELD OF THE INVENTION

The present invention relates to a method and system for performing consumer transactions. In particular, the present invention relates to an offline, voice-enabled, consumer transaction system using voice recognition and authentication technology.

### BACKGROUND OF THE INVENTION

The conventional manner of making a consumer purchase is for a consumer to physically go to a retail store and complete the transaction directly with a sales person. To allow consumers more flexibility while shopping some business establishments allow consumers for make purchases over the telephone or over the Internet (e.g., a remote sale). However, conventional remote sale systems have several shortcomings.

For example, the consumers may be placed in waiting queues for customer service representatives to be come free or experience processing delays/problems over the Internet. In addition, the customer service representatives and Internet sites are generally not able to provide comprehensive catalog, inventory and promotional information to the consumer. Thus, the consumer may not obtain the best deal or even obtain exactly what is desired.

In addition, most retail stores and other businesses that accept credit card type-transactions for effectuating a remote (i.e., a purchase facilitated over the telephone) sale need to have an accurate mechanism for verifying a customer's identify to avoid fraudulent transactions. Despite conventional precautionary attempts to prevent illegal transactions, credit card frauds are still rampant in many business establishments.

What is needed, therefore, is a system for more effectively facilitating remote consumer transactions that may also be able to verify the identification of credit card users at a lower cost. Such a system should also provide consumers with the best deal regarding their commercial transactions and allow both participating merchants and consumers to experience enhanced security.

### SUMMARY OF THE INVENTION

According to one aspect of the invention, a method is provided gathering information related to a desired item or service. The method includes the steps of receiving a voice data packet related to a desired item or service and forming a search request using information from the voice data packet. The search request may include audio information. The method also includes the steps of searching one or more databases for the desired item or service and providing a result of the search to the user.

According to another aspect of the invention, a system is provided to perform a commercial transaction. The system includes an input interface capable of receiving audio data related to a user and a desired item or service and a processor capable of forming a search request based upon information from the audio data, transmitting the search request to a search engine, receiving a search result, and providing a result indication to the user. The system also includes a user interface capable of receiving an authorization from the user to perchance the desired item or service.

Another embodiment of the invention is directed to a transaction system including a device for receiving audio data relating to a user of the system and a desired item or service, and a search formatter that can create a search request based upon the audio data, and a search engine arranged to search one or more resource databases and provide a search result to a user. The user can then purchase the desired item or service.

Yet another aspect of the invention relates to providing a user with product or service comparison information to provide the user an optimum search result in accordance their needs or desires.

These and other advantages will become apparent to those skilled in this art upon reading the following detailed description in conjunction with the accompanying drawings.

### BRIEF DESCRIPTION OF THE DRAWINGS

FIG. 1 is a representation of the voice authentication/transaction system in accordance with one aspect of the present invention;

FIG. 2 is a simplified block diagram of the voice authentication/transaction system and its associated network in accordance with another aspect of the present invention;

FIG. 3 is a flow chart of the operation of the voice transaction process in accordance with one embodiment of the present invention;

FIG. 4 illustrates various types of data that can be used to verify a user's identity in accordance with another embodiment of the present invention; and

FIG. 5 is an illustration of a sub-system that can simultaneously perform a search of a structured resource base and a fuzzy search of an unstructured resource base to obtain results that may be provided to a user of a voice authentication/transaction system according to an other embodiment of the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for purposes of simplicity and clarity, detailed descriptions of well-known devices, circuits, and methods are omitted so as not to obscure the description of the present invention with unnecessary detail.

A typical remote consumer transaction may be initiated by a consumer calling an order processing center of a commercial establishment, for example, a toll free number from a store catalog. The consumer then identifies the goods to be purchased, provides payment information (e.g., credit or debit card information), and shipping information, i.e., a home address. The order processing center then processes the order based upon the information provided. The present invention is applicable in this type of transaction by allowing merchants to process the transaction in an offline manner, i.e., not in real time. The present invention may also be used by consumers to obtain the best deal, bargain-hunt or optimize their commercial transaction.

In particular, the present invention utilizes a speech recognition system to initiate the consumer transaction. In one embodiment, the present invention allows consumers to purchase merchandize or services in an offline process using a voice communication interface via a voice data packet. It should be understood that the voice data packet may contain any type of audio/sound data. The voice communication interface may include a lap-top computer, a mobile phone, or other mobile computer devices, such as a personal digital assistant (PDA), a personal communication assistant (PCA), an electronic organizer, an interactive TV/set-top box remote control, or any interactive devices with voice input or text to voice capabilities.

A voice data protocol may be used to facilitate the exchange of the voice data packet. In this regard, the consumer contacts a speech recognition system coupled (or integrated) to a voice data gateway, which facilitates the communication of voice print data via a telecommunication switch or Internet router.

For example, VoiceXML technology may be used to facilitate voice recognition and/or authentication during processing of the voice data packet as discussed below. It is noted, however, that other types of voice communication interfaces can also be used.

VoiceXML is a Web-based markup language for representing human-computer dialogs, just like HTML. However, unlike the HTML, which provides a graphical web browser with display, keyboard, and mouse, the Voice XML is a voice browser with audio output (computer-synthesized and/or recorded), and audio input (voice and/or keypad tones), thus simplifying voice application. Typically, the VoiceXML voice browser runs on a specialized voice gateway node that is connected both to the public switched telephone network and the Internet. Communicating voice print data is well known in the art that can be performed in a variety of ways. See for example, The VoiceXML Forum, IEEE Industry Standards, and Technology Organization (IEEE-ISTO), the contents of which are hereby incorporated by reference.

In operation, the consumer creates a voice data packet which contains information necessary for completion of a merchandize purchase (e.g., an electronic device or other consumer-type good). The voice data packet should contain, or have access to, one or more of follow types of information:

1. Consumer Information (e.g. name, address, telephone number)

2. Merchandize/Service Description (e.g., manufacturer, model, options)

3. Merchandize/service Source (e.g., store name, retailer, manufacturer, etc.)

4. Financial Information (e.g., quantity, price or price range, payment mechanism, e.g., credit card, COD, etc.)

5. Shipping information (e.g., customer pick-up or shipping address)

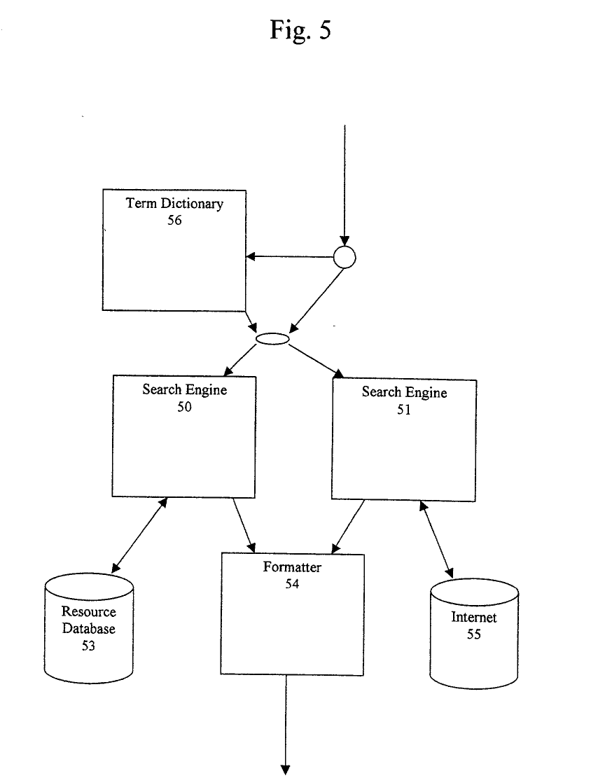

The type and amount of information may vary as long as a minimal amount of information is provided to complete the transaction. Otherwise the consumer may get (1) an error message that more information is required, e.g., a quantity, or (2) the system's best guess is used for the product(s) the consumer desired. The system's best guess procedure is discussed below in connection to FIG. 5.

It is also noted that consumer profiles can be created so that information used repeatedly need not be entered again, i.e., the consumer information. These profiles may be accessed via key words or identification numbers, e.g., predetermined consumer information may be accessed via the consumer's social security number, password, or the consumer's name, which serve as the key word.

The following is an example of the voice data packet information spoken/input by a typical user:

| | |
|---|---|
| Consumer: | John Doe; |
| Merchandize: | Philips DVD player Model 123; |
| Cost: | Under $150.00; and |
| Ship: | [to] Home. |

In this example, John Doe and Home are key words that will allow the system to access predetermined information regarding the consumer identity and shipping address.

The various embodiments and aspects of the present invention provide numerous benefits and advantages to the consumer. For example, the consumer does not have to wait in check out lines, call constantly busy 800 numbers or get tied-up waiting for an on-line purchase to go through. One aspect of the offline process of the present invention includes the feature of searching for the best deal for the consumer without forcing the consumer to do any time-consuming product research.

Some of the possible applications are described in the following cases:

A consumer is watching TV and sees a commercial for a desirable product. The consumer can then create a voice data packet via a phone, web-enabled TV, or other handy voice communication device and place an offline purchase order for that item.

The same scenario may apply for a consumer reading a magazine and notices a product advertisement.

A consumer walking through a department store can create a voice data packet to purchase an item using a cell phone. When the consumer is ready to leave, the item may be pick-up on the way out of the store. In this case, if the consumer used a credit card for payment, the item would already be paid for at the time of pick-up.

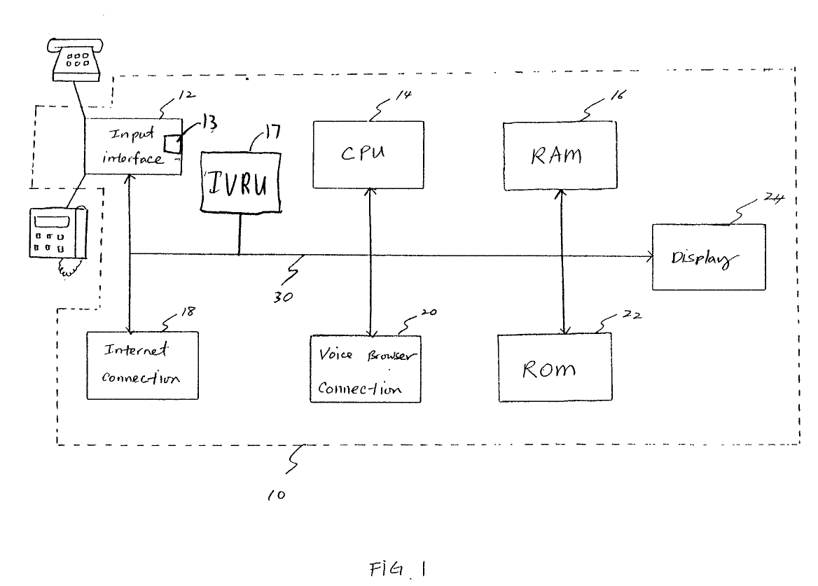

Referring now to FIG. 1, a terminal 10 on which the voice transaction process of the present invention may be implemented is shown. The exemplary terminal 10 of FIG. 1 is for descriptive purposes only. Although the description may refer to terms commonly used in describing particular computer systems, the description and concepts equally apply to other processing systems, including systems having architectures dissimilar to that shown in FIG. 1.

Major components of the terminal 10 that enable a voice transaction process include an input interface 12 for receiving a transaction request and for initiating the voice transaction. The input interface 12 may include speech to text capability to covert all or part of an audio input from the consumer to electronic text 13. The terminal 10 also includes a central processing unit (CPU) 14, which may be provided, for example, as a conventional microprocessor; a random access memory (RAM) 16 for temporary storage of information; an Internet connection circuit 18 for communicating over the web; a voice browser 20 for providing audio input and output; a read only memory (ROM) 22 for permanent storage of information; and, a display circuit 24. Each of the aforementioned components may be directly or indirectly coupled to a bus 30.

It is noted, however, that one or more of the above noted components can be integrated into a single component that has the same functionality.

Operation of the terminal 10 is generally controlled and coordinated by operating system software, which controls the allocation of system resources and performs tasks such as processing, scheduling, memory management, networking, and I/O services, among other things. Thus, the operating system resident in the memory 22 or RAM 16, and executed by CPU 14, coordinates the operation of the other elements of the terminal 10.

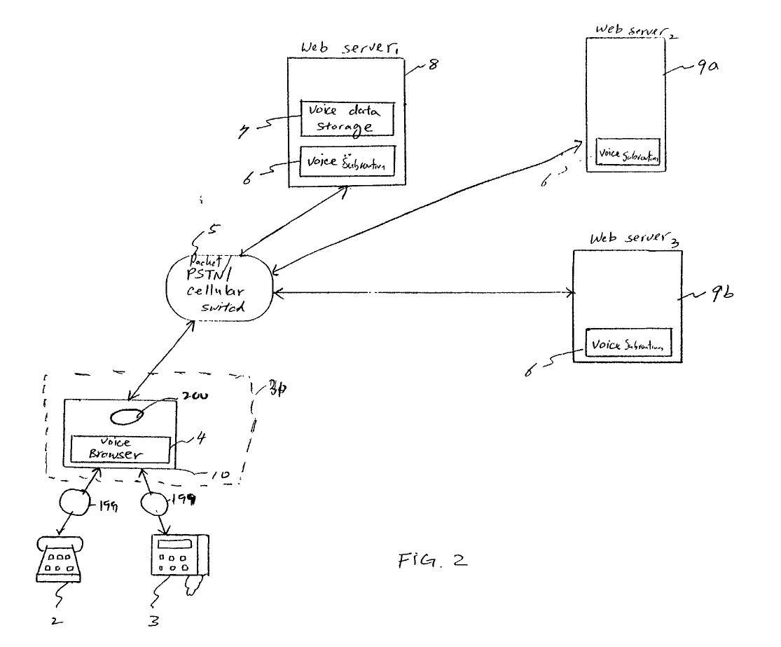

FIG. 2 is a diagrammatic illustration of a preferred embodiment of a voice transaction network of the present invention. However, many other configurations are possible, as would be apparent to one skilled in the art, and the present invention is not meant to be limited to any particular type of network. The terminal 10 shown in FIG. 1 may be located at an order processing center 31.

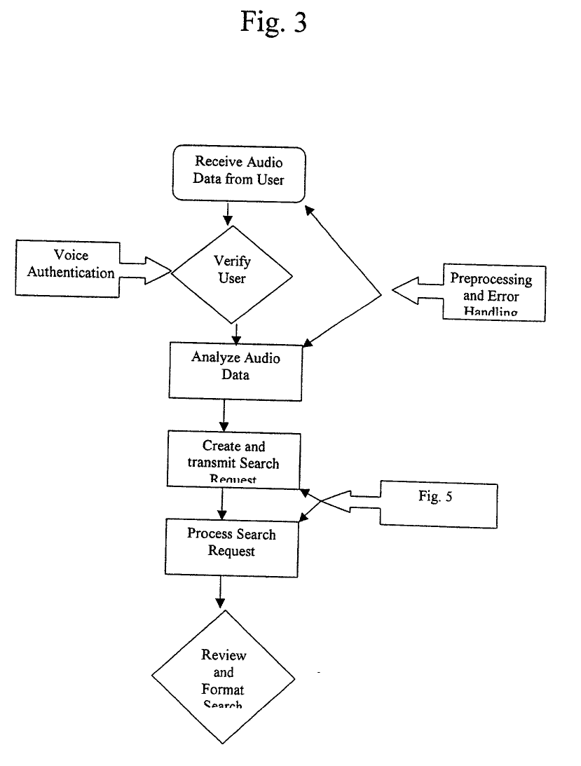

FIG. 3 is a flow diagram illustrating the operation steps performed during one embodiment of the present invention to provide a voice transaction process. Some or all of the steps shown in FIG. 3 can be implements as a computer program stored on a computer readable medium. The computer program, when executed, e.g., by the processor 14, causes various functions to be performed as described herein. As shown in FIG. 3, the rectangular elements indicate computer software instructions, whereas the diamond-shaped element represents computer software instructions that affect the execution of the computer software instructions represented by the rectangular blocks. It will be appreciated by those of ordinary skill in the art that unless otherwise indicated herein, the particular sequence of steps described is illustrative only and can be varied without departing from the spirit of the invention.

The voice transaction processing is initiated when the terminal 10 receives audio data 199 from a consumer. The audio data 199 is used to create a voice data packet 200. The voice data packet 200 may also be formed using some or all of the electronic text 13. The voice browser 20 may also be capable of directly transforming the audio input from the consumer into the corresponding voice data packet 200 format so that it may be transmitted in the form of VoiceXML responses, HTML, XML or the like. The voice data packet 200 may also be transmitted as data via a telephone circuit connection.

In step 100, the identity of the consumer is verified. In one embodiment, this may be performed by voice authentication by comparing the customer information data to a pre-stored voice print of the consumer. (Formation of the pre-stored voice print database is discussed below). It is noted, however, that the voice authentication is optional and/or may be performed at any time before the completion of the transaction. The consumer's identity can also be verified using a password system or other such conventional security systems.

In the voice authentication process, for example, the voice data packet 200 may be transmitted to a credit card issuing company's server 8 for verifying the consumer's identity in a credit card type consumer transaction. When the voice data packet 200 is received by a server 8, a database 7 is accessed to verify the consumer's credit and the identification of the consumer. The remote server 8 searches the database 7 to establish a match with a pre-recorded verification reference data of the consumer.

The comparison process is performed to determine whether voice prints from the voice data packet 200 matches the pre-recorded voice reference data of the consumer requesting the transaction to be performed. The voice match indicates that the voice signature of the stored voice reference data matches the voice signature of the input voice data. For background information on voice authentication and voice recognition see U.S. Pat. Nos. 5,499,288, 5,127,043, 5,297,183 and 5,297,194, incorporated by reference herein. If a match is not established, the customer may be notified of the failure in a predetermined manner (e.g., voice message, e-mail, regular mail). One or more failed voice authentication attempts may also trigger inactivation of the credit or debit card. If a match is established, the consumer's identity is accepted, and the credit card holder is now allowed to complete the purchase.

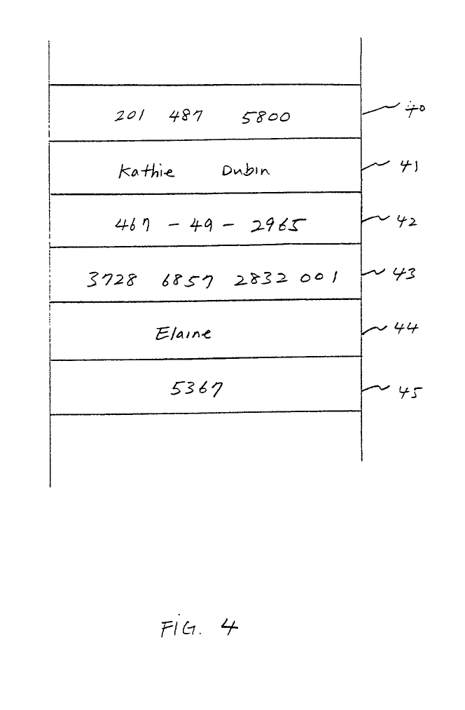

The database 7 may be formed by credit card companies as part of the customer's credit or debit card initialization process. For example, the customer may be required to call a specified number and speak various combinations of words or numbers which then will be stored as voice verification reference data in the database 7. As shown in FIG. 4, the various combination of words or numbers may include, a telephone number 40, a name 41, a social security number 42, a credit card number 43, a nick name 44 or a pin number 45. The verification reference data are typical pieces of information used in verifying a user's identity. This information is also typical information needed to perform a credit card transaction over the telephone or via the Internet.

The server system 8 may be accessed by the terminal 10 through a wide area network, such as the public telephone network, cellular or packet switched network 5, or an Internet router that routes TCP/IP datagrams.

The remote server 8 may also have access to secondary web servers (not shown) to execute the same or different verification process. For example, other entities may also create voice databases, i.e., the department of motor vehicles, telephone companies, wireless providers, etc. These secondary databases may be accessed based upon the customer's driver's license, home telephone number, or other personal information.

In step 110, the terminal 10 analyzes the voice data packet 200. Based upon the information within the voice data packet 200, a search is formulated for the desired item. This search is formulated using the Merchandize Description and/or the Merchandize Source information. Additional details regarding how the search may be performed is discussed below in relation to FIG. 5.

In step 120, the terminal 10 establishes a communication channel to one or more servers 9a, 9b. These servers 9a, 9b may be local or remote. This communication channel may be a dial or dedicated connection. There may be pre-defined searchable databases or known websites related to various categories of goods. In addition, web crawlers may be sent out to search third party databases or web sites for the merchandize.

It is noted that the servers 8, 9a and 9b generally will also include voice data processing subroutines 6 that are used to process the voice data packets 200. Although the severs 9a, 9b need not have such voice data processing subroutines in only the electronic text 13 is used as the basis of the search request.

In step 130, the server(s) 9a, 9b then processes the search request and respond to the terminal 10.

Now referring to FIG. 5, one system to facilitate the search discussed above uses components of modern information retrieval technology to provide flexibility. Information from the voice data packet 200 (as discussed above the may include audio data and/or electronic text) is provided to search engines 50 and 51. The search engine 50 is programmed to search one or more resource databases indicated symbolically at 53, for example, a resource database maintained by a goods or product provider or a provider of services. It is assumed that the search engine 50 is programmed to accept the indicated information from the voice data packet 200 and that typical formatting steps are employed to formulate a query and obtain results which are the output to a formatter 54.

The search engine 51 searches the Internet 55. For example, the search engine 51 could incorporate a search engine such as Google®. The query used for searching is, preferably, generated from the contents of the voice data packet 200 either directly or indirectly. For example, if the voice data packet 200 contains only a general product category and a manufacturer, it may be necessary for some process (not illustrated) to look it up on a remote server, or perhaps an internal database, to determine additional information such as one or more model numbers offered by the manufacturer that fit the general product category.

Alternatively, one or more characterizations of the item or goods to be located may be pre-stored. For example, the characterization could contain the label “DVD.” Once the nature of the consumer good is determined, it can be incorporated in a search query by the search engine 51. A characterization of the consumer good to be located may be done in the same way. A unique identifier code can be assigned to certain goods, as well as, a characterization (or multiple alternative characterizations) for purposes of formulating a query for the search engine 51. The same may be done with any profile data. For example, the query could contain a particular set of profile data that is specifically set aside for Internet searches. Alternatively, the profile data may be left out for the Internet search by the search engine 51. The query may employ a template, or set of templates for alternate queries. The results retrieved by the search engine 51 may then be sent to the formatter 54 and arranged into an output for the consumer.

Note, the term “resource database” is used here to identify any kind of data space that is computer-addressable including the World Wide Web, databases, servers such as news feeds, media feeds, with connections via packet and switched services such as the Internet and regular telephone and cellular phone services. Resources in the resource database may be data or process objects so that the resources found in searching the resource space may result in the initiation of a process, such as the automatic control of a remote system, the automatic initiation or completion of a transaction, or the initiation of a dialog with a consumer. The resource base may be made and maintained by any entity and can be a conduit, such as a web content aggregator, that combines resources from several sources.

In another embodiment of the present embodiment, the information contained in the voice data packet 200 may be filtered through a term dictionary 56 before being incorporated in a query by the search engine 51. The term dictionary 56 may process audio and/or electronic text inputs. The term dictionary 56 provides words and phrases that have some relationship to critical terms supplied by the consumer. These relationships can be synonyms, hypernyms, terms that indicate where or how a thing characterized by a search term is normally used, etc.

The need for the term dictionary 56 is that the user/consumer may be unable to precisely specify what type of consumer good is desired. An example of a type of dictionary that is currently used in formulating search queries from an input search query is a thesaurus of synonyms.

An example of a dictionary that relates terms to other terms along a variety of different dimensions is WordNet, a lexical dictionary used in the field of computational linguistics. WordNet relates words to other words that are related to a subject word along various dimensions. It provides hypernyms, antonyms, meronyms (meronym is a word that names a part of a given word), holonyms (holonym is a word that names the whole of which a given word is a part), attributes, entailments, causes, and other types of related words. Such a dictionary could be used to create alternative queries that would have a much higher likelihood of producing useful results under certain circumstances.

Instead of formulating a single query (or several based on synonyms from a thesaurus or alternative terms by stemming), significant terms in the original query may be selectively expanded by means of a specialized “dictionary.”

The alternative is for the system to have a generic dictionary that it can use to expand any terms, and filter the results based on the quality of the matches obtained.

One way the search process can be improved is to insure that queries and the indices employed by the search engines 50 and 51 use the canonical form of query terms. The canonical forms may include stemming and replacement, if necessary, by one chosen canonical stem term to replace a variety of synonyms of the stem. This would be done with query terms and descriptive text (including metatags) in the resources. The advantage of allowing resources to use terms other than standardized terms is that it allows them to be generated more easily and by persons with less technical sophistication. Creators of resources can simply borrow descriptive language from another source or draft it without being concerned with conforming to a standard vocabulary.

The search results are provided to the user/consumer via the formatter 54. Search hits that are deemed high priority, for example by the confidence level of the hit, such as indicated by most Internet search engines and used for ranking results may be provided first. Other criteria may be used to rank the results, such as the presence of a predetermined indicator, in the resource.

The search techniques can identify a particular resource and invariably generate an indication of goodness of fit, i.e., a measure of how appropriate each response is to the given set of input data. The response(s) is (are) then selected based on which produced the best fit to the input data.

A more practical way to make a response database is to draw on technology being used in search engine and question-answering systems where the criteria for selection and the contents of the responses are natural language descriptors. In question-answering systems (or frequently asked question; FAQ selectors), a natural language (NL) question is parsed to identify the most significant terms. These are then compared to templates in the FAQ database. The templates are derived from the questions to which the corresponding answers are responses.

As an alternative embodiment, the terminal 10 may also include an interactive voice response unit 17 to facilitate the questioning and answering process. This type of Q&A can be used to fine tune the information provided by the consumer.

An extension of this technology would be for the templates to be ordered sets, each element corresponding to a particular type of input. For example, a first element could correspond to “what,” indicating one or more consumer product identifiers relating to the desired item. Other elements might correspond to the sources or manufacturers of the consumer product. The input vector may be ordered in the same way. One way of expressing the ordering is by data-tagging, for example using XML.

In practice, processes for matching inputs to responses using either-or comparisons between the components of input and template vectors could be used to correlate responses quite effectively in a practical system, even though the number of responses and input combinations may be high. Usually in programming such a system, many vector components would be ignored, reducing the size of the input vector space. Also, the provider may classify the kinds of requests to be received, and provide some default response when no input vector matches a response template. For example, assume the information provider is a manufacturer who provides information to support purchasers of its products. The manufacturer may match each request identifying one of its products to a corresponding set of responses. When the request fails to match, the server programming might generate a default response/match.

Now returning to FIG. 3, in step 140, if a match is found by the server(s) 9a, 9b, a determination is made if the requested item can be purchased in accordance with the financial information provided. If yes, the item is shipped to the consumer in accordance with the shipping information or the consumer is notified that the item is ready to pick-up. In the latter case, the notification can be made via e-mail, phone (e.g., an interactive voice response unit) or letter. The location of the item would also be specified.

In another embodiment, consumer may also reject or cancel the purchase when the confirmation notice is received (but before the product is shipped or picked-up.). The consumer may also receive multiple confirmation notices related to the same voice data packet purchase order. In this situation, the consumer may pick the best deal and cancel (not acknowledge) the other confirmation notices.

It should also be understood that the consumer does not ever need to actually complete the transaction. The system shown in FIG. 2, for example, may be used by the consumer to merely gather information about the desired item or service.

Having thus described several embodiments of the present invention, it should be apparent to those skilled in the art that certain advantages of the system have been achieved. The foregoing is to be constructed as only being illustrative embodiments of this invention. Persons skilled in the art can easily conceive of alternative arrangements providing functionality similar to this embodiment without any deviation from the fundamental principles or the scope of this invention. Moreover, the present invention is operable to provide voice authentication for check transactions and other operations requiring user identification.

What is claimed is:

1. A method for providing information related to a desired item or service, the method comprising the steps of:
receiving a voice data packet related to a desired item or service;
forming a search request using information from the voice data packet, the search request including audio information;
searching one or more databases for the desired item or service; and
providing a result of the search to the user.

2. The method of claim 1, wherein, the information includes one or more of the following types of information: consumer information, merchandize/service description, merchandize/service source, financial information and shipping information.

3. The method of claim 2, wherein the result may be used by the user to complete a purchase transaction for the desired item or service.

4. The method of claim 1, wherein the searching step includes searching one or more databases over the Internet.

5. The method of claim 3, wherein the purchase transaction is a credit or debit card transaction.

6. The method of claim 1, further comprising the step of verifying the user's identity using a voice authentication process.

7. A system for performing a commercial transaction, comprising:
an input interface capable of receiving audio data related to a user and a desired item or service;
a processor capable of forming a search request based upon information from the audio data, transmitting the search request to a search engine, receiving a search result, and providing a result indication to the user; and
a user interface capable of receiving an authorization from the user to perchance the desired item or service.

8. The system of claim 7, further comprising means to complete the perchance of the desired item or service.

9. The system of claim 7, further comprising an interactive voice response unit.

10. The system of claim 7, wherein said processor includes a voice browser to transmit the audio data packet.

11. The system of claim 7, wherein the search engine searches predefined databases and the Internet.

12. The system of claim 8, further comprising voice authentication means to verify the identity if the user using the audio data.

13. The system of claim 7, further comprising an audio-to-text unit, wherein at least a portion of the search request includes electronic text data.

14. The system of claim 7, further comprising a result indication formatter that formats the search results in a predetermined order.

15. A transaction system, comprising:
means for receiving audio data relating to a user of the system and a desired item or service;
means for creating a search request based upon the audio data;
means for searching one or more resource databases;
means for providing a search result; and
means for purchasing the desired item or service.

16. The system of claim 15, wherein the audio data also includes merchandize/service description related to the desired item or service and financial information related to the user.

17. The system of claim 15, wherein the means for searching includes searching for product or service comparison information to provide the user an optimum search result in accordance with the audio data.
